(19) United States
(12) Patent Application Publication
(10) Pub. No.: US 2017/0305078 A1
(43) Pub. Date: Oct. 26, 2017

(54) METHOD FOR PRODUCING CONTINUOUS COMPOSITE SANDWICH STRUCTURES BY PULTRUSION

(71) Applicant: FPInnovations, Pointe-Claire (CA)

(72) Inventors: Halim CHTOUROU, Kirkland (CA); Michelle Agnes RICARD, Pointe-des-Cascades (CA)

(73) Assignee: FPInnovations

(21) Appl. No.: 15/492,170

(22) Filed: Apr. 20, 2017

Related U.S. Application Data
(60) Provisional application No. 62/324,988, filed on Apr. 20, 2016.

(51) Int. Cl. B29C 70/52

(52) U.S. Cl. CPC B29C 70/526; B29C 70/528

(57) ABSTRACT

The present relates to a composite sandwich structure comprising a central core made of pultruded lightweight yarns and outer composite skin of pultruded reinforcement fiber rovings. It is provided a method of producing a composite sandwich structure comprising providing pultruded lightweight and co-impregnated yarns, and a co-pultruded reinforcement fiber rovings; and guiding the pultruded lightweight yarns to form a central core and the pultruded reinforcement fiber rovings forming an outer composite skin within at least one heated pultrusion die producing a composite sandwich structure.

### CROSS-REFERENCE TO RELATED APPLICATIONS

The present application claims benefit of U.S. Provisional Application No. 62/324,988 filed Apr. 20, 2016, the content of which is hereby incorporated by reference in its entirety.

### TECHNICAL FIELD

The present relates to a composite sandwich structure comprising a central core made of pultruded lightweight yarns and outer composite skin of pultruded reinforcement fiber rovings.

### BACKGROUND ART

Pultrusion is a continuous process suited to manufacture straight composite profiles with constant cross-section. In order to manufacture articles having any desired constant cross-section from fiber reinforced thermosetting resins, the process consists of pulling a stock of reinforcement fiber rovings through guiding plates, then through a pre-formulated resin bath, then through the preforming plates, and finally through a heated formation die, corresponding to the desired constant cross-section, in order to cure the resin and form the articles into their final continuous shapes. Typical reinforcement rovings that are commercially pultruded include mostly fiberglass and carbon fiber.

Currently, in most applications, composite pultruded parts are from 20% to 50% more expensive than competing materials (e.g.: extruded metals and reinforced plastics). Nevertheless, pultrusion is the most cost effective composite manufacturing process, even cheaper than the chop spray and the filament winding processes.

U.S. Pat. No. 2,818,606 discloses that other reinforcing materials, other than fiberglass, such as cotton, silk, nylon, asbestos or the like can be used. Wood fibers, paper or the like may also be employed. Furthermore, it is specified that the purpose of these particular materials is merely to serve as a vehicle for advancing plastic material into the molds. The plastic material constitutes the main body of the molded article and the fibrous material contributes little to the characteristics of the end products. Moreover, the upper platen of the forming die needs to be drawn up just after releasing the hydraulic ram pressure in order to pull out the molded article from the longitudinal mold.

In order to ensure uniform resin distribution within the pultruded product, even when the fiberglass content is significantly reduced, WO 1989/001863 combined cellulosic fibers that may be either air laid or wet laid, to the plurality of longitudinal fiberglass rovings. For the same purpose, other noncellulosic short fibers such as polyolefin fibers, fiberglass, and mixtures thereof were disclosed to form hybrid pultruded products where the plurality of continuous fiberglass rovings are the main effective longitudinal reinforcement and constitute the pulling tool of the cured products.

Recently, Hazizan et al. (2010, Materials Science and Engineering, 527: 2942-2950) studied the flexural behavior of pultruded natural fibers and fiberglass hybrid polyester composites. Natural fibers from jute and kenaf were used in twisted roving form and hybrid pultruded laminates were tested. The reported results showed that with a configuration having by weight 45% of jute fiber twisted roving and 25% of fiberglass roving, flexural strength averaged 350 MPa and flexural modulus averaged 25 GPa.

More recently, Chandra et al. (2014, Journal of Chemical and Pharmaceutical Research, 6: 626-628) used only local kenaf fiber twisted roving in pultrusion process with polyester resin. The reported results showed that with 70% of fiber volume fraction a maximum flexural strength is attainable, corresponding to an average of 250 MPa.

U.S. Pat. No. 4,752,513 discloses a resin reinforcing composite mats of continuous rovings suitable for pultrusion processes permitting transversal reinforcement of the pultruded parts. U.S. 2002/0014302 discloses pultruded pre-impregnated material comprising fibers impregnated with a partially cured resin, which has been introduced into a pultrusion die with a barrier layer between the surface of the prepreg material and facing inner surfaces of the die. The barrier layer is continuously removed from each surface after exiting the die.

Accordingly, there is still a need to be provided with a pultrusion process which provides a raw material cost saving leading to an improvement in the pultruded product competitiveness.

### SUMMARY

In accordance with the present invention there is now provided a method of producing a composite sandwich structure comprising providing pultruded lightweight and co-impregnated yarns, and co-pultruded reinforcement fiber rovings; and guiding the pultruded lightweight yarns to form a central core and the pultruded reinforcement fiber rovings forming an outer composite skin within at least one heated pultrusion die producing a composite sandwich structure.

In accordance with another embodiment, it is also provided a composite sandwich structure comprising a central core of pultruded lightweight yarns and an outer composite skin of pultruded reinforcement fiber rovings.

In accordance with another embodiment, it is also provided a composite sandwich structure made by the method described herein.

In an embodiment, the pultruded lightweight yarns are at least one of paper twines, natural fibers twisted rovings and engineered lightweight extruded or pultruded flexible thermoplastic based wires.

In another embodiment, the natural fibers are for instance from jute, hemp, kenaf or bamboo.

In a further embodiment, wherein the pultruded continuous reinforcement fiber rovings are from for instance glass fibers, basalt fibers, carbon fibers, and aramid fibers, in a homogenous or a commingled form.

In an additional embodiment, the paper twines are from at least one of northern bleached softwood kraft, bleached hardwood kraft pulp, bleached chemi-thermomechanical pulp, thermo-mechanical pulp, pulp from non-wood plants, synthetic pulp, and a combination thereof.

In an embodiment, at least one of the pultruded lightweight yarns and the pultruded reinforcement fiber rovings are impregnated with a resin.

In another embodiment, the resin is a resin is a thermoset resin or a thermoplastic resin.

In an alternative embodiment, the resin is a polyester resin, a vinylester resin, an epoxy resin, a polyurethane resin, a phenolic resin, a polyethylene resin, a polypropylene resin, a polybutylene succinate resin, a polyurethane resin or a polyamide multipolymer resin.

In another embodiment, the at least one of the pultruded lightweight yarns and the pultruded reinforcement fiber rovings are impregnated with the resin in at least one resin bath.

In another embodiment, the at least one of the pultruded lightweight yarns and the pultruded reinforcement fiber rovings are fully or partially impregnated with the resin.

In an embodiment, the pultruded lightweight yarns are paper twines, the reinforcement fiber rovings are glass fiber rovings and at least one of the pultruded lightweight yarns and the pultruded reinforcement fiber rovings are impregnated with a thermoset resin.

In another embodiment, the resin is a thermoplastic resin with suitable melting flow rate, melting temperature and a viscosity level favorable to impregnate the pultruded lightweight yarns and the pultruded reinforcement fiber rovings.

In another embodiment, the pultruded lightweight yarns and the pultruded reinforcement fiber rovings are first impregnated with low viscosity monomers premixed with an initiator, an activator, and suitable additives like pigments or functional fillers and then continuously pulled through the pultrusion die where the thermoplastic polymer is synthetized in-situ under the die pressure and heat.

In an embodiment, the pultruded lightweight yarns and the pultruded reinforcement fiber rovings are co-pultruded through a guide system ensuring external guiding of the pultruded reinforcement fiber rovings and central guiding of the pultruded lightweight yarns.

In another embodiment, the guiding system comprises preform plates or the like.

In a further embodiment, the pultruded lightweight yarns are guided through a final guiding device just before the heated pultrusion die ensuring a precise positioning of the pultruded lightweight yarns.

In a further embodiment, the bulk density of the pultruded lightweight yarns is from about 0.5 to 1.2 g/cm³.

In an additional embodiment, the fiber density of the pultruded reinforcement rovings is from about 1.4 to 2.6 g/cm³.

In an additional embodiment, the heated pultrusion die is maintained in at least three zones of temperatures.

In an embodiment, the heated pultrusion die is maintained in three zones of temperatures of about 245° F., about 295° F. and about 265° F.

In another embodiment, the composite sandwich structure is produced by providing a first group of reinforcement fiber rovings; guiding the first group of reinforcement fiber rovings within a first heated pultrusion die forming a first structure; providing a second group of reinforcement fiber rovings to the first structure; and guiding the second group of reinforcement fiber rovings and the first structure within a second heated pultrusion die forming the composite sandwich structure

In an embodiment, the method described herein further comprises the step of pulling the composite sandwich structure.

In an embodiment, the composite sandwich structure is pulled for instance at a fixed speed of about 0.33 m/min.

In another embodiment, the composite sandwich structure is cut to a predetermined length.

### BRIEF DESCRIPTION OF THE DRAWINGS

Reference will now be made to the accompanying drawings.

FIG. 1 illustrates a continuous pultrusion process as known in the art.

FIG. 2A illustrates a continuous pultrusion process using reinforcement fiber rovings and lightweight yarns or paper twines according to one embodiment encompassed herein.

FIG. 2B illustrates cross-sectional views of a pultruded sandwich embodiments as encompassed herein having continuous pultruded cores.

FIG. 3 illustrates a perspective view of a unidirectional elongated core made from NBSK paper twine straps and epoxy resin.

FIG. 4 illustrates a longitudinal face view of an epoxy bonded sandwich panel made from a unidirectional elongated NBSK paper twine strap based core and two pultruded skins made from polyester resin and fiberglass rovings.

FIG. 5 illustrates a comparative analysis of the stiffness of the sandwich panel described herein and shown at FIG. 4 and a two-epoxy bonded—skins made by pultrusion of fiberglass rovings in polyester resin.

FIG. 6 illustrates a comparative analysis of the flexural stiffness effectiveness of the NBSK paper twine strap based core (▪) described herein and the aluminum honeycomb core (•) with respect to core/skin thickness ratio in sandwich panels.

FIG. 7 illustrates a perspective view of the reinforcement fiber rovings 10 (—) and the paper twines (---) 11 as being pulled through the guiding/preform plate 14, the resin bath 12, and the preform plates 14 before the pultrusion die 16.

FIG. 8 illustrates a top view of the impregnated reinforcement fiber rovings 10 and the paper twines 11 as being pulled through the preform plates 14 and the elongated plastic funnel 17 (only paper twines) before the sandwich rod forming die 16.

FIG. 9 illustrates a cross-sectional (A) and surface (B) views of the pultruded sandwich rod made from 1.2 mm paper twines, fiberglass rovings and polyester resin.

FIG. 10 illustrates a cross-sectional view of the pultruded sandwich rod made from 2 mm paper twines, fiberglass rovings and polyester resin.

FIG. 11 illustrates a cross-sectional view of the pultruded sandwich rod made from 2 mm jute fiber twines, fiberglass rovings and polyester resin.

FIG. 12 illustrates a final guiding and centering device designed to be screwed to the pultrusion heated die to form the 16 mm sandwich rods.

FIG. 13 illustrates cross-sectional views of other typical pultruded sandwich paper twine-reinforcement fiber composite structures in accordance with an embodiment.

FIG. 14 illustrates a continuous pultrusion process in accordance to another embodiment with two subsequent resin baths and heated dies as herein described.

It will be noted that throughout the appended drawings, like features are identified by like reference numerals.

### DETAILED DESCRIPTION

It is provided a composite sandwich structure comprising a central core made of pultruded lightweight yarns and outer composite skin of pultruded reinforcement fiber rovings. It is further provided a method of producing a composite sandwich structure comprising providing pultruded lightweight yarns and co-impregnated, and a co-pultruded reinforcement fiber rovings; and guiding the pultruded lightweight yarns to form a central core and the pultruded reinforcement fiber rovings forming an outer composite skin within a heated pultrusion die producing a composite sandwich structure.

The present disclosure includes a new method for producing composite sandwich structures by the pultrusion process. In the pultrusion processes known in the art, only the reinforcement fiber, such as fiberglass rovings and carbon fiber tows, are impregnated with thermoset or thermoplastic resins and then continuously pulled through the pultrusion final shaping die. In the case of thermoset resins, the pultrusion die is heated to ensure the resin curing and therefore the formation of the composite structures. On the contrary, the present process describes pultrudable lightweight yarns such as paper twines or natural fiber twisted rovings or engineered lightweight extruded or pultruded thermoplastic based wires, which are co-impregnated and co-pultruded with the reinforcement fiber rovings, then properly guided to form a central core within the heated pultrusion die. The reinforcement fiber rovings are also precisely guided to form the outer composite skin around the continuously formed lightweight core. In this concept of in situ continuous core formation, the lightweight yarns such as paper twines are suitable and versatile for all geometric profiles being produced by the pultrusion process. An alternative process describes the potential use of two sets of reinforcement fiber rovings, two subsequent impregnation baths with similar or different but compatible resin systems and two subsequent pultrusion dies to produce continuous structures in sandwich profiles.

In order to manufacture articles having any desired constant cross-section from fiber reinforced polymeric resins, known processes essentially consist of for example pulling a stock of reinforcement fiber rovings 10 through a pre-formulated thermoset resin bath 12, then through the preform plates 14, and finally through a heated formation die 16 (FIG. 1A), corresponding to the desired constant cross-section, in order to cure the resin and form the articles into their final continuous shapes, while being pulled 18 and cut with a saw 20. Typical reinforcement rovings that are commercially pultruded include mostly glass and carbon fibers.

Using an inner filling body, EP 0 753 394 describes sandwich boards for scaffolding and formworks by a pultrusion process. The inner filling bodies, such as balsa, wood, or synthetic foam, were fed to the formation and polymerization mold without substantial discontinuity in the form of geometrically finished elements in a substantially central position with respect to the continuous fiber materials. The continuous fiber materials constitute the multi-layered outer reinforcement face (composite skin) of the sandwich boards.

Dissimilar to the process described herein, U.S. Pat. No. 5,632,837 discloses a process to manufacture composite sandwich rod assemblies by the pultrusion process, that may be used, for example, as a tool handle. The process described therein includes the steps of feeding a core into a pultrusion die tube and surrounding the core with resin coated fibers. In that process, the mold and the product may have a non-uniform cross-section as they are being co-drawn from the die tube by means of a mobile belt that is guided through a track. Following the same approach of core insertion into the pultrusion die, U.S. 2002/0014302 describes a method to produce pultruded composite structural parts, like a sandwich structure, in which one or more rigid, pre-rigidized, or rigidizable composite or non-composite structural elements are introduced at regular or irregular positions within the core elements.

Dissimilar to EP 0 753 394 and U.S. Pat. No. 5,632,837, in the process described herein, for example pultruded fiberglass/polyester sandwich rod (16 mm diameter), the central core is continuously formed in-situ from, for example, northern bleached softwood kraft (NBSK) paper twines impregnated with unsaturated polyester resin. Such sandwich rods are lighter and have higher specific flexural properties compared to a fully composite rod formed from only fiberglass rovings and polyester resin.

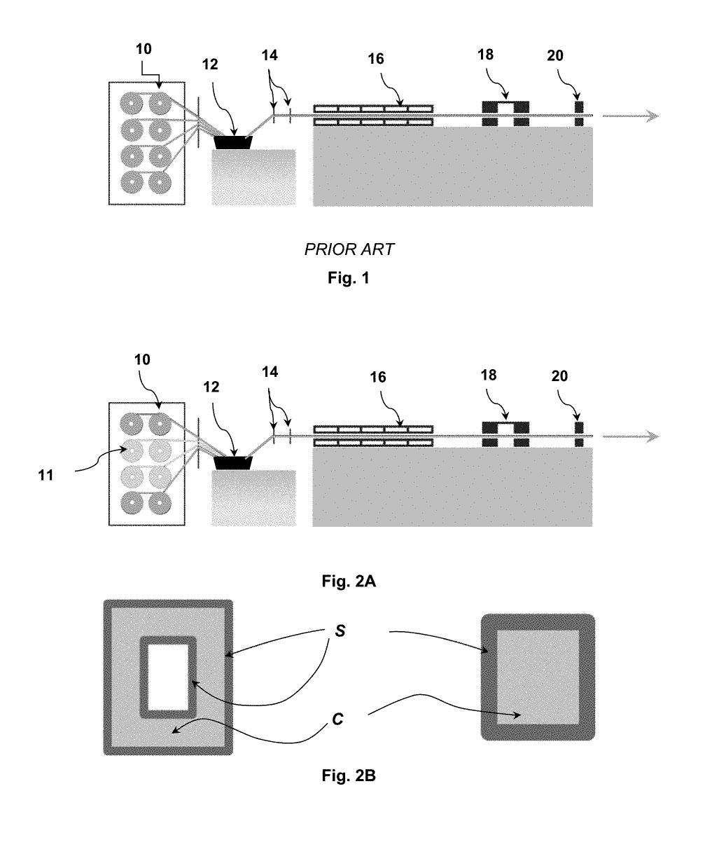

Accordingly, it is described the use of lightweight yarns 11 such as natural fiber rovings or engineered synthetic rovings, or cellulosic paper twines (twisted strings) in a conventional pultrusion process, in conjunction with the continuous reinforcement fiber 10 rovings (FIG. 2A), to form sandwich composite profiles (FIG. 2B). Such use of these lighter density materials as core C surrounded by a composite skin S forming various sandwich composite profiles (FIG. 2B) during the pultrusion process described herein has not been previously described. The present disclosure therefore also describes how to form in situ continuous cores or sandwich composite profiles via a pultrusion process.

Alternatively, it is also encompassed the formation of a composite sandwich structure as described herein produced by two subsequent pultrusion dies (see FIG. 14).

Essentially, the first pultrusion die 16 profile corresponds exactly to the shape and size of the core that while being co-pultruded through the second pultrusion die 16′ a top structural skin is being bonded to the core surface and the two subsequent dies are precisely aligned with respect to the central axe of their respective profiles.

As seen in FIG. 14, the pultruded reinforcement fiber rovings are gathered in two separate groups (10 and 10′). The first pultruded reinforcement fiber rovings 10 are impregnated with a low density resin like syntactic resin containing hollow microspheres or a specially formulated resin containing a desired void content once processed in-situ in first heated die 16, to form a lightweight fiber reinforced core continuously sandwiched with surrounded pultruded reinforcement fiber rovings.

In an embodiment, the weight fraction of the first pultruded reinforcement fiber rovings 10 with respect to the continuous pultruded lightweight core is for instance in the range of 40 to 50%.

In a further embodiment, the bulk density of the pultruded lightweight core is from about 0.9 to 1.2 g/cm³.

The second pultruded reinforcement fiber rovings 10′ are impregnated with a conventional resin, which may be similar or different to the first resin but without hollow microspheres, prior to be guided to form the sandwich skin while the preformed pultruded core and said second impregnated reinforcement fiber rovings 10′ are all pultruded through the second heated die 16′ for final profile shaping.

In another embodiment, the resin is a thermoplastic resin with suitable melting flow rate, melting temperature and a viscosity level favorable to impregnate the pultruded lightweight yarns and the pultruded reinforcement fiber rovings.

In a further embodiment, the resin is for instance a polyethylene resin, a polypropylene resin, a polybutylene succinate resin, a polyurethane resin, a polyamide multipolymer resin, and the like.

In another embodiment, higher thermoplastic impregnation quality may be achieved through a reactive pultrusion process as described for example in U.S. Pat. No. 5,374,385. In such embodiment, the pultruded lightweight yarns and the pultruded reinforcement fiber rovings are first impregnated with low viscosity monomers premixed with an initiator, an activator, and suitable additives like pigments or functional fillers and then continuously pulled through the pultrusion die where the thermoplastic polymer is synthetized in-situ under the die pressure and heat.

In an embodiment, the low density resin is for example in the range of 0.5 to 0.7 g/cm³ comprising formulated unsaturated polyester resin and hollow glass microspheres.

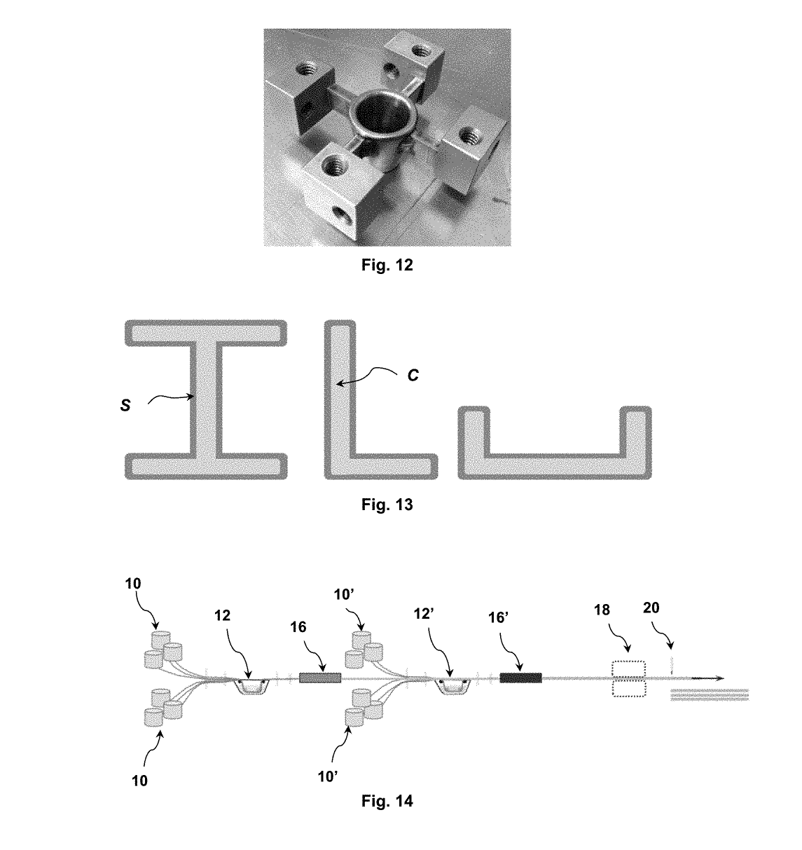

In accordance with one embodiment, a multiplicity of continuous cellulosic paper twines are used with continuous fiberglass rovings to form a sandwich reinforced polyester pultruded rod. More particularly, continuous sandwich rod is made by co-pulling the fiberglass rovings and the continuous lightweight paper twines for in situ composite skin and core formation inside the pultrusion die. A forming guide system composed of plastic machined plates is used to ensure external guiding for the fiberglass rovings and central guiding for the paper twines. In one embodiment, a long plastic funnel is introduced just before the pultrusion heated die to ensure that the paper twines are properly centered with respect to the surrounding fiberglass rovings. In one embodiment, a centering device (FIG. 12) is fixed to the pultrusion heated die to ensure more precise centering of the impregnated lightweight yarns. In these sandwich rod embodiments, all processing parameters are maintained the same as those used for the fiberglass control rod. Also encompassed herein are the uses of jute natural fiber rovings and the use of two grades of paper twines for comparison purpose.

Paper twines are commercially available for niche markets like special wrapping, decoration, and paper bag handles. More specifically, bleached kraft paper twines are used to manufacture repulpable paper straps for wrapping dry pulps. Repulpable paper straps are traditionally formed from 13-15 northern bleached softwood kraft (NBSK) paper twines jointly bonded with a water soluble binder such as polyvinyl alcohol (U.S. 20160355981 A1).

Bulk densities of many commercial repulpable NBSK paper straps (width ranging from 17 to 19 mm) are in the range of 0.5-0.78 g/cm³. This density range is relatively low compared with the fiberglass roving that has a density of 2.56 g/cm³. The availability of the paper twines in continuous form makes them suitable for pultrusion process. Ever more relevant, paper twines can be used in the inner pultruded section as a core, whereas the fiberglass rovings can be guided to form the outer composite sandwich skin. It is disclosed herein that paper twine can allow significant weight savings when compared to pultruded fiber reinforced thermoset plastics without negative impact on flexural properties. The composite exterior skin also ensures protection against moisture absorption from ambient environment as well as against water diffusion in case the sandwich pultruded part is in contact with water. In case of fire resistant resin, the exterior composite skin for example from glass fiber reinforced fire resistant resin also ensures higher protection against fire than would do a simple paper twine reinforced fire resistant resin.

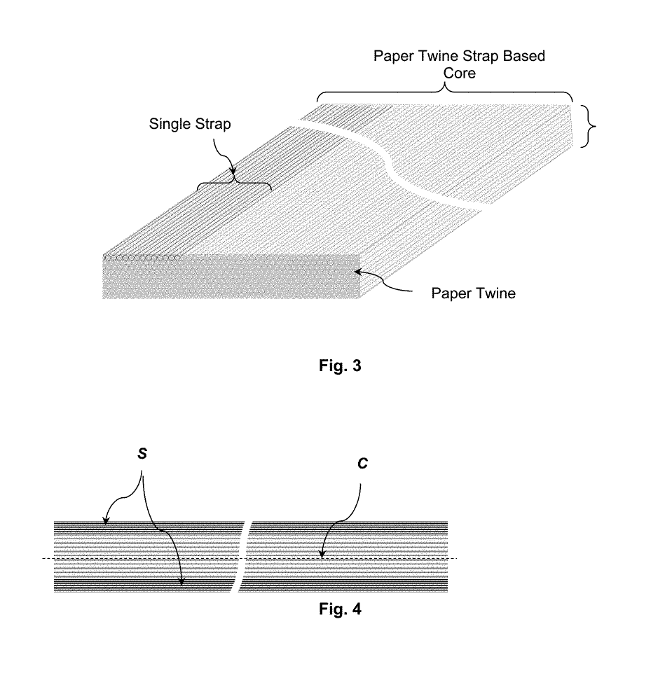

In accordance with the present invention, FIG. 3 shows one way of forming a paper twine based core from paper twine straps. In this case, paper twines that were preformed into a commercially available paper strap were used to prove the concept prior to pultrusion trials with paper twines. FIG. 3 shows a plurality of NBSK paper straps bonded together with an epoxy resin (epoxy content ˜8% by weight) and then slightly compressed to form an elongated unidirectional core from NBSK paper twine strap with a bulk density of ˜0.75 g/cm³. FIG. 4 shows how an elongated sandwich is then assembled using the preformed core from NBSK paper twine strap C, two pre-pultruded polyester/continuous fiberglass roving laminates (skins) S, and an epoxy resin as a binder.

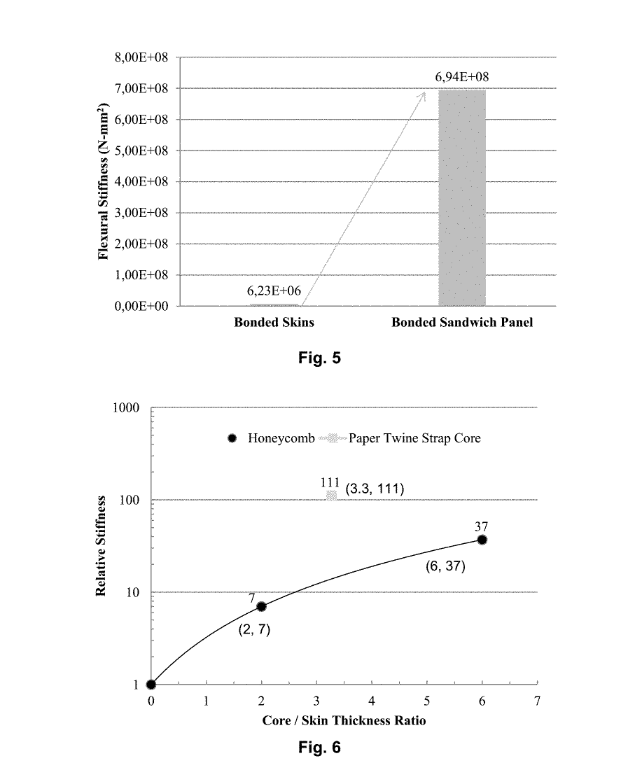

FIG. 5 illustrates the effect (increase of 111 times) of the NBSK paper twine strap based core on the flexural stiffness with respect to that of the same two epoxy bonded skins. In comparison with honeycomb effectiveness in composite flexural stiffness increase, as plotted with respect to core/skin thickness ratio, FIG. 6 elucidates a net superiority for the NBSK paper twine strap based core which allows a relative stiffness increase of 111 times at a core to skin thickness ratio of 3.3, compared to only ˜14 times at the same core/skin thickness ratio. This comparison is based only on the core to skin thickness ratios and does not take into consideration the respective core densities.

Unlike the conventional lightweight core materials, such as honeycomb, balsa and synthetic foam panels, and taking into consideration the different complex profiles being produced by pultrusion process, paper twines and similar lightweight continuous rovings might become interesting geometrically versatile materials that can be easily guided through the preforming plates and then co-pultruded with the reinforcement rovings through the pultrusion die for the production of sandwich composite structures.

As stated in previous paragraphs and as no core material is presently available in continuous form, such as roving, or the like, to become suitable for all types of pultrudable profiles such as rods, rectangular bars, I-beams, U-beams, hollow rods, or hollow rectangular bar, a continuous core formation process is described herein using a multiplicity of paper twines, or the like, jointly bonded while being co-pulled with the reinforcing fiber rovings into the pultrusion heated die for the production of lightweight and cost-effective pultruded sandwich composites.

In accordance with the following embodiments, it is provided new raw materials for the pultrusion process suitable for continuous in situ core formation. These new raw materials include, but are not limited to, continuous paper twines from NBSK pulp or any other wood pulps such as bleached hardwood kraft pulp, bleached chemi-thermomechanical pulp (BCTMP), thermo-mechanical pulp (TMP), as well as continuous rovings made from non-wood or agricultural pulps such as cotton, hemp, flax, jute, kenaf, or bamboo, etc. or any combination thereof. These new raw materials that shall be suitable for continuous in situ core formation inside the pultrusion die may include also, but are not limited to, any continuous lightweight engineered yarns or extruded or pultruded flexible thermoplastic based wires containing suitable fossil-fuel or biobased polymers, or a combination thereof.

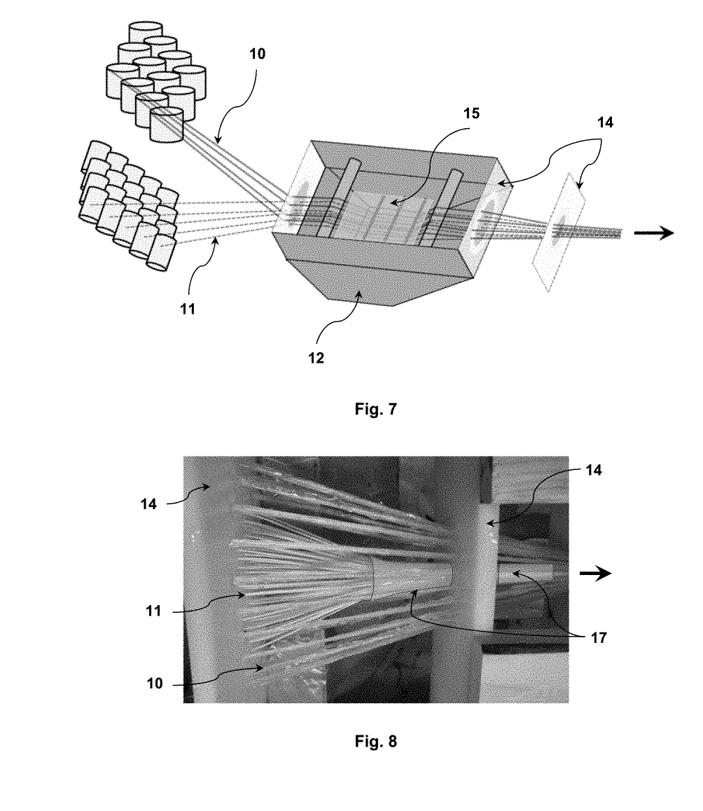

In accordance with an embodiment, paper twines 11, or alternative lightweight yarns used for continuous in situ core formation, can be simultaneously fully or partially impregnated along with any other reinforcement fiber rovings (FIG. 7). For partially impregnated twines, only a fraction of the paper twines 11 goes into the resin bath 12 in order to minimize resin 15 content inside the pultruded core structure. Paper twines 11 can also, but not preferably, feed the heated pultrusion die directly without passing into the resin bath. In this case, fully impregnated reinforcement fiber rovings 10 may transfer their excess wet resin towards the interior non-impregnated paper twines 11 just while entering into the heated pultrusion die 16.

As disclosed herein, a 16 mm diameter pultrusion die 16, typically used to form fully composite rods (control) from polyester and fiberglass rovings 10 (33 rovings, 8858 tex each), was used for forming a sandwich rod. In one embodiment, eighty nine (89) NBSK paper twines 11 (˜1 mm in diameter each) were used to make the interior circular core structure C having approximately 10 mm in diameter. The surrounding sandwich rod composite skin (˜3 mm thick) was formed using twenty two (22) fiberglass rovings 10 (8858 tex each). FIG. 8 shows the sandwich rod preform guiding system to ensure proper positioning of the fiberglass rovings 10 and the NBSK paper twines 11. The preform guiding system was composed of three plastic machined plates 14 and an elongated plastic funnel 17 properly sized and positioned to gather the NBSK paper twines 11 into the central section of the sandwich rod.

In another embodiment (FIG. 10), twenty nine (29) NBSK paper twines 11 (˜2 mm in diameter each) were used to make the interior circular core structure C having approximately 12 mm in diameter. The surrounding sandwich rod composite skin (˜2 mm thick) was formed using eighteen (18) fiberglass rovings 10 (8858 tex each). In a further embodiment (FIG. 11), thirty (30) twisted jute fiber yarns 11 (˜2 mm in diameter each) were used to make the interior circular core structure C having approximately 11 mm in diameter. The surrounding sandwich rod composite skin (˜2.5 mm thick) was formed using twenty two (22) fiberglass rovings 10 (8858 tex each).

In accordance with another embodiment, FIG. 12 shows a core centering device for a 16 mm sandwich rod designed to be screwed to the pultrusion die to ensure proper positioning of the lightweight yarns 11 to be surrounded by the reinforcement fiber rovings.

In accordance with the present disclosure, for many less structural applications, paper twines could be used without any other typical reinforcement fiber rovings to form pultruded paper twine reinforced thermoset or thermoplastic resins. Paper twines could also be used with thin composite skins to convey higher stiffness and strength with respect to the one without reinforcing fiber rovings.

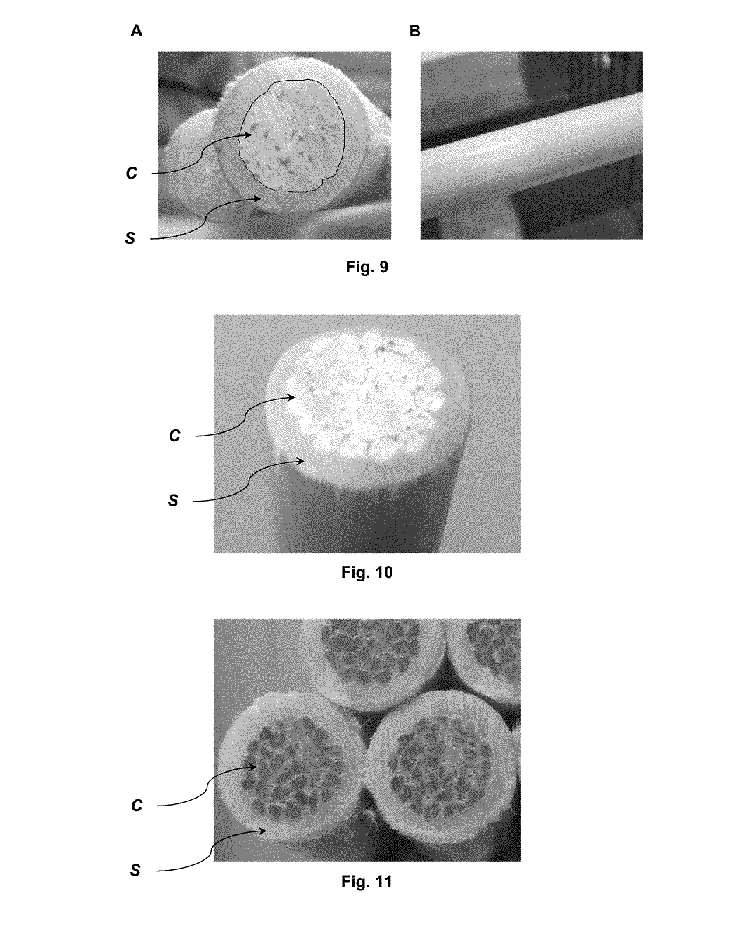

In accordance with an embodiment, the three zone temperatures of the formation die are maintained at 245° F., 295° F., and 265° F., and the pulling speed is fixed at 0.33 m/min using a puller, same as the original set-up for the fully fiberglass/polyester rod. FIG. 9 shows cross-sectional and surface views of the pultruded sandwich rod. On a qualitative basis, paper twines did not inhibit the curing profile of the polyester formulated resin. Visual inspection of the sandwich and the control rods, at the cross-sectional and the external surfaces, shows similar curing and finishing quality.

In accordance with other embodiments, sandwich rods are successfully pultruded neither without any modification in the formation die curing parameters nor in the pulling mechanism. Therefore, NBSK paper twines are shown to have a good potential in pultrusion process as secondary raw material rovings for continuous in-situ core formation.

Table 1 presents densities (ASTM D792-13) and flexural properties (ASTM D790, Span: 32/1) of three pultruded sandwich rods in comparison with two commercial reference rods made from fiberglass rovings and polyester resin. NBSK paper twines and jute fiber twine are weight effective allowing a weight saving of about 28% in the case of the 2 mm paper twine and of about 17% in the case of the 1.2 mm paper twine and the jute fiber twine. These weight savings are achieved while the flexural properties remain in the range of the commercial reference rods. Furthermore, specific flexural properties of the sandwich rods are higher than those of the commercial rods (Table 1). As illustrated in Table 1, the pultruded sandwich rods did not break from the bottom side as did the control rod (tensile breaking mode). They broke from the top side in compression mode. Higher resin content at the sandwich skin is required to ensure higher bonding strength between the skin reinforcement fiber rovings as well as at the skin/core interface and thus to prevent premature compressive failure.

TABLE 1
Specifications and flexural properties of pultruded 16 mm sandwich rods in
comparison with commercial reference rods

| | Lightweight Yarns— | | | | |
|---|---|---|---|---|---|
| | E-Glass/Polyester | | | | |
| | Paper | Paper | Jute | Commercial | |
| | Twine~1 | Twine~2 | Twine~2 | E-Glass/Polyester | |
| Rod/Properties | mm | mm | mm | PROForms ® | Pultex ® |
| Density ρ; g/cm³ | 1.70 | 1.48 | 1.71 | 2.04 | 2.06 |
| Skin Resin Content; Wt. % | 19.0 | 19.2 | 16.4 | 33.3 | 23.6 |
| Core Resin Content; Wt. % | 42.4 | 42.8 | 41.5 | — | — |
| Core Calculated Void; Vol. % | 11.3 | 28.3 | 4.3 | — | — |
| Core Calculated ρ; g/cm³ | 1.21 | 0.98 | 1.23 | — | — |
| Flexural Strength; MPa | 802 | 754 | 687 | 867 | 690 |
| Flexural Modulus; GPa | 45.7 | 38.5 | 47.0 | 42.5 | 41.2 |
| Flexural Strength to Specific | 471.8 | 503 | 402 | 425 | 335 |
| Gravity Ratio; MPa/(g/cm³) | | | | | |
| Flexural Modulus to Specific | 26.9 | 25.7 | 27.5 | 20.8 | 20.0 |
| Gravity Ratio; GPa/(g/cm³) | | | | | |
| Flexural Strain (%) | 1.7 | 2.0 | 1.7 | 2.3 | 1.8 |

FIG. 13 illustrates more pultrudable embodiments of different sandwich geometries where NBSK paper twines are suitable to form continuous cores while being pulled through the pultrusion die. Furthermore, it is highlighted that the weight saving, with respect to equivalent volume profiles, might reach ˜30% at equal core/skin thickness ratios, depending on the profile geometry size and the respective paper twine core fraction.

It is thus provided a new and geometrically versatile method for producing in situ continuous composite sandwich structures by the disclosed pultrusion process. The present process provides new applications for paper twines, natural fiber rovings, and other engineered lightweight continuous yarns or extruded or pultruded flexible thermoplastic based wires, as core material in advanced pultruded composite sandwich structures. The novel core formation concept described herein is perfectly suitable for the pultrusion process independently from the pultruded profile.

The pultrudable paper twines, or any suitable lightweight yarns, are co-impregnated and co-pultruded with the reinforcement fiber rovings, but guided using a proper device to the pultrusion die entrance to form a central core made of pultruded paper twines, or any suitable lightweight yarns, bonded with the cured resin within the heated pultrusion die. The co-impregnated reinforcement fiber rovings are simultaneously guided through preform plates to form the composite skin surrounding the continuously formed paper twine based core.

The resulting pultruded sandwich structures have a lighter weight that may reach 30%, due to the use of the paper twines, or any suitable lightweight yarns, for in situ continuous core formation, without reduction of the absolute flexural properties. Accordingly, the process described herein provides a means to increase volume based cost savings ($/m³) associated with the differences in the market prices ($/kg) and related densities (e.g.: pultruded paper twines ˜844 kg/m³, fiberglass roving ˜2560 kg/m³, and carbon fiber tow ˜1800 kg/m³).

While the disclosure has been described in connection with specific embodiments thereof, it will be understood that it is capable of further modifications and this application is intended to cover any variations, uses, or adaptations of the description following, including such departures from the present disclosure as come within known or customary practice within the art to which the disclosure pertains and as may be applied to the essential features hereinbefore set forth, and as follows in the scope of the appended claims.

What is claimed is:

1. A method of producing a composite sandwich structure comprising:
providing pultruded and co-impregnated lightweight yarns, and a co-pultruded reinforcement fiber rovings; and
guiding the pultruded lightweight yarns to form a central core and the pultruded reinforcement fiber rovings forming an outer composite skin within at least one heated pultrusion die producing a composite sandwich structure.

2. The method of claim 1, wherein pultruded lightweight yarns is at least one of paper twines, natural fibers twisted rovings, engineered lightweight extruded flexible thermoplastic based wires and engineered lightweight pultruded flexible thermoplastic based wires.

3. The method of claim 2, wherein the natural fibers are from jute, hemp, kenaf or bamboo.

4. The method of claim 1, wherein the pultruded reinforcement fiber rovings are from at least one of glass fibers, basalt fibers, carbon fibers, aramid fibers and other engineered reinforcement fibres.

5. The method of claim 4, wherein pultruded reinforcement fiber rovings are in a homogenous or a commingled form.

6. The method of claim 2, wherein the paper twines are from at least one of northern bleached softwood kraft, bleached hardwood kraft pulp, bleached chemi-thermomechanical pulp, thermo-mechanical pulp, pulp from non-wood plants, synthetic pulp and a combination thereof.

7. The method of claim 6, wherein at least one of the pultruded lightweight yarns and the pultruded reinforcement fiber rovings are impregnated with a resin.

8. The method of claim 7, wherein the resin is a thermoset resin or a thermoplastic resin.

9. The method of claim 8, wherein the resin is a polyester resin, a vinylester resin, an epoxy resin, a polyurethane resin, a phenolic resin, a polyethylene resin, a polypropylene resin, a polybutylene succinate resin, a polyurethane resin or a polyamide multipolymer resin.

10. The method of claim 9, wherein the at least one of the pultruded lightweight yarns and the pultruded reinforcement fiber rovings are impregnated with the resin in at least one resin bath.

11. The method of claim 10, wherein the at least one of the pultruded lightweight yarns and the pultruded reinforcement fiber rovings are fully or partially impregnated with the resin.

12. The method of claim 1, wherein the pultruded lightweight yarns are paper twines, the reinforcement fiber rovings are glass fiber rovings and at least one of the pultruded lightweight yarns and the pultruded reinforcement fiber rovings are impregnated with a thermoset resin.

13. The method of claim 1, wherein the pultruded lightweight yarns and the pultruded reinforcement fiber rovings are co-pultruded trough a guide system ensuring external guiding of the pultruded reinforcement fiber rovings and central guiding of the pultruded lightweight yarns.

14. The method of claim 1, wherein the guiding system comprises preform plates.

15. The method of claim 1, wherein the pultruded lightweight yarns are guided through a final guiding device just before the at least one heated pultrusion die.

16. The method of claim 1, wherein the bulk density of the pultruded lightweight yarns is from about 0.5 to 1.2 g/cm³.

17. The method of claim 1, wherein the fiber density of the pultruded reinforcement rovings is from about 1.4 to 2.6 g/cm³.

18. The method of claim 1, wherein the composite sandwich structure is produced by
providing a first group of reinforcement fiber rovings;
guiding the first group of reinforcement fiber rovings within a first heated pultrusion die forming a first structure;
providing a second group of reinforcement fiber rovings to said first structure; and
guiding the second group of reinforcement fiber rovings and the first structure within a second heated pultrusion die forming the composite sandwich structure.

19. The method of claim 1, further comprising the step of pulling the composite sandwich structure.

20. A composite sandwich structure made by the method of claim 1.
